(19) United States
(12) Patent Application Publication
(10) Pub. No.: US 2025/0063622 A1
(43) Pub. Date: Feb. 20, 2025

(54) METHOD PERFORMED BY USER EQUIPMENT AND USER EQUIPMENT

(71) Applicant: SHARP KABUSHIKI KAISHA, Sakai City, Osaka (JP)

(72) Inventors: CHONGMING ZHANG, Shanghai (CN); RENMAO LIU, Shanghai (CN)

(21) Appl. No.: 18/724,584

(22) PCT Filed: Dec. 27, 2022
(86) PCT No.: PCT/CN2022/142315

§ 371 Date: Jun. 26, 2024

(30) Foreign Application Priority Data
Dec. 28, 2021 (CN) 202111628359.X

(51) Int. Cl. H04W 76/20; H04W 76/30; H04W 92/18

(52) U.S. Cl. CPC H04W 76/20; H04W 76/30; H04W 92/18

(57) ABSTRACT

The present invention provides a method performed by user equipment, and user equipment. The method is a processing method performed in a procedure wherein a remote user equipment (UE) A and another remote user equipment (UE) B set up a sidelink (SL) connection or a PC5 connection by means of a relay UE, including the following step: when scenario I or a scenario II described below occurs between one of the UE A and UE B and the relay UE, initiating, by the relay UE, a notification procedure to notify the other one of the UE A and UE B, scenario I being that a radio link failure (RLF) has occurred on the SL connection or the PC5 connection between the one of the UE A and UE B and the relay UE, and scenario II being that the relay UE has received a request from an upper layer to release the PC5 connection or the SL connection with the one of the UE A and the UE B.

### TECHNICAL FIELD

The present invention relates to the technical field of wireless communications. More specifically, the present invention relates to a method performed by user equipment, and corresponding user equipment.

### BACKGROUND

A remote UE can perform communication connection with another remote UE by means of a relay UE. It is assumed that one of the remote UE is remote UE-A, and the other remote UE is remote UE-B. A PC5 connection is set up between the remote UE-A and the relay UE, and a PC5 connection is also set up between the remote UE-B and the relay UE. By means of the relay UE, a logical PC5 connection is set up between the remote UE-A and the remote UE-B.

How to manage communication between the remote UE-A and the remote UE-B when a communication link between the relay UE and one of the remote UE is faulty is a problem that needs to be solved.

### SUMMARY

In order to solve the above problem, the present invention provides a method performed by user equipment, and user equipment. In the scenario that a logical PC5 connection has been set up between a remote UE-A and a remote UE-B, when a communication link between a relay UE and one of the remote UE is faulty, communication between the remote UE-A and the remote UE-B can be effectively managed.

According to one aspect of the present invention, provided is a method performed by user equipment, the method being a processing method performed in a procedure wherein a remote user equipment (UE) A and another remote user equipment (UE) B set up a sidelink (SL) connection or a PC5 connection by means of a relay UE, comprising the following step:
when scenario I or scenario II described below occurs between one of the UE A and UE B and the relay UE, initiating, by the relay UE, a notification procedure to notify the other one of the UE A and UE B,
scenario I being that a radio link failure (RLF) has occurred on the SL connection or the PC5 connection between the one of the UE A and UE B and the relay UE, and
scenario II being that the relay UE has received a request from an upper layer to release the PC5 connection or the SL connection with the one of the UE A and UE B.

In the above-described method performed by user equipment, preferably,
when the SL connection between the one of the UE A and UE B and the relay UE corresponds to a destination,
the scenario I is that on the SL connection corresponding to the destination of the one of the UE A and UE B, the relay UE has detected an RLF or an RLF has occurred, and
the scenario II is that the relay UE has received a request from the upper layer to release a PC5-RRC connection, and the connection is destined for the one of the UE A and UE B or a destination of the connection corresponds to the one of the UE A and UE B.

In the above-described method performed by user equipment, preferably,
in the initiated notification procedure, the relay UE transmits a first message to the other one of the UE A and UE B to notify that an RLF has occurred on the SL connection between the relay UE and the one of the UE A and UE B or that a corresponding PC5-RRC connection has been released.

In the above-described method performed by user equipment, preferably,
the relay UE sets an indication type according to a reason for triggering the transmission of the first message.

In the above-described method performed by user equipment, preferably,
if the reason for triggering the transmission of the first message is the scenario I, then the relay UE sets the indication type as SL RLF or PC5 RLF, or
if the reason for triggering the transmission of the first message is the scenario II, then the relay UE sets the indication type as SL release or PC5 release.

In the above-described method performed by user equipment, preferably,
the relay UE causes the set indication type to be carried in the first message, and transmits the same to the other one of the UE A and UE B.

In the above-described method performed by user equipment, preferably,
the first message further carries identification information, and the identification information is for identifying information of one of the UE A and UE B in the scenario I or the scenario II.

In the above-described method performed by user equipment, preferably,
when the other one of the UE A and UE B receives the first message, it is determined that an RLF has occurred on the SL connection set up between the other one of the UE A and UE B and the one of the UE A and UE B, and the following operations are performed for the SL connection between the UE A and the UE B or the SL connection destined for the one of UE A and the UE B:
determining that an RLF has occurred on the connection between the UE A and the UE B, or an RLF has occurred or been detected on the connection corresponding to the destination of the one of the UE A and UE B;
releasing a DRB and/or an SRB corresponding to the destination;
releasing configuration information in a SRAP and corresponding to the destination or associated with the destination;
if a timer T400 associated with the destination is running, stopping the timer;
discarding NR SL communication related configuration information associated with the destination;
determining that the PC5-RRC connection associated with the destination has been released; or
indicating to the upper layer that the PC5-RRC connection associated with the destination has been released.

In the above-described method performed by user equipment, preferably,
when the one of the UE A and UE B detects that an RLF has occurred on the connection between the one of the UE A and UE B and the relay UE, or the upper layer of the one of the UE A and UE B requests the one of the UE A and UE B to release a PC5-RRC connection with the relay UE,
if the one of the UE A and UE B has a PC5-RRC connection/SL connection set up with the other one of the UE A and UE B by means of the relay UE,
first, the following operations are performed for the SL connection between the one of the UE A and UE B and the relay UE or corresponding to the SL connection destined for the relay UE:
releasing a DRB and/or an SRB associated with the destination;
discarding NR SL communication related configuration information and/or U2U relay related configuration information associated with the destination;
determining that the PC5-RRC connection associated with the destination has been released;
indicating to the upper layer that the PC5-RRC connection associated with the destination has been released; or
resetting a MAC entity associated with the destination,
and then, the following operations are performed for the connection between the UE A and the UE B:
determining that an RLF has occurred on the connection between the UE A and the UE B, or an RLF has occurred or been detected on the SL connection corresponding to the destination of the UE B;
releasing a DRB and/or an SRB associated with the destination;
releasing configuration information in a SRAP and corresponding to the destination or associated with the destination;
if a timer T400 associated with the destination is running, stopping the timer;
discarding NR SL communication related configuration information associated with the destination;
determining that the PC5-RRC connection associated with the destination has been released; or
indicating to the upper layer that the PC5-RRC connection associated with the destination has been released.

According to another aspect of the present invention, user equipment is provided, comprising:
a processor; and
a memory storing instructions,
the instructions, when run by the processor, causing the user equipment to perform the method described above.

According to the method performed by user equipment and corresponding user equipment to which the present invention relates, when the communication link between the relay UE and one of the remote UE is faulty, communication between the remote UE-A and the remote UE-B can be effectively managed.

### BRIEF DESCRIPTION OF THE DRAWINGS

FIG. 1 is a schematic diagram showing U2U relay.

FIG. 2 is a schematic diagram showing control plane protocol stacks in the communication mode in FIG. 1.

FIG. 3 shows a method performed by user equipment (UE) according to an embodiment of the present invention.

FIG. 4 is a simplified structural block diagram of user equipment according to the present invention.

### DETAILED DESCRIPTION

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

Prior to the specific description, several terms mentioned in the present invention are illustrated as follows. The terms involved in the present invention shall have the meanings set forth below, unless otherwise indicated.
UE: User Equipment
NR: New Radio
LTE: Long Term Evolution
eLTE: enhanced Long Term Evolution
RRC: Radio Resource Control
MAC: Medium Access Control (layer)
MAC CE: MAC Control Element
SDAP: Service Data Adaptation Protocol
SRAP: Sidelink Relay Adaptation Protocol
RLC: Radio Link Control
PDCP: Packet Data Convergence Protocol
ADAPT: adaptation layer
PHY: physical layer
RB: Radio Bearer
DRB: Data Radio Bearer
SRB: Signaling Radio Bearer
PDU: Protocol Data Unit
SDU: Service Data Unit
V2X: Vehicle-to-Everything

A plurality of embodiments according to the present invention are specifically described below, with an NR mobile communications system and its subsequent evolved version serving as exemplary application environments, and with a base station and UE that support NR serving as examples. However, it should be noted that the present invention is not limited to the following embodiments, but is applicable to more other wireless communications systems, such as an eLTE communication system, or an NB-IoT system, or an LTE-M system. Moreover, the present invention may be applicable to other base stations and user equipment, such as base stations and user equipment supporting eLTE/NB-IoT/LTE-M.

### Proximity Services (Prose) Communication Between UE (UE to UE, U2U Communication)

A UE and a UE may be wirelessly connected to each other by using a Proximity services communication means, so as to achieve transmission of data or signaling. The Proximity services communication means mentioned herein primarily refers to a sidelink connection. The Proximity services communication means could also refer to a Wi-Fi connection or other connection means. A sidelink connection-based reference point between a UE and a UE is referred to as PC5, and therefore a sidelink-based connection between the UE may be referred to as a PC5 connection. Sidelink connection and PC5 connection are interchangeable herein. Such a PC5 connection may be identified by a pair of Layer-2 identities (IDs) typically including a source Layer-2 identity (ID) and a destination Layer-2 identity (ID). Such a PC5 connection may be simply referred to as a PC5 connection, a sidelink connection, or the like for or corresponding to a certain address.

### U2U Relay

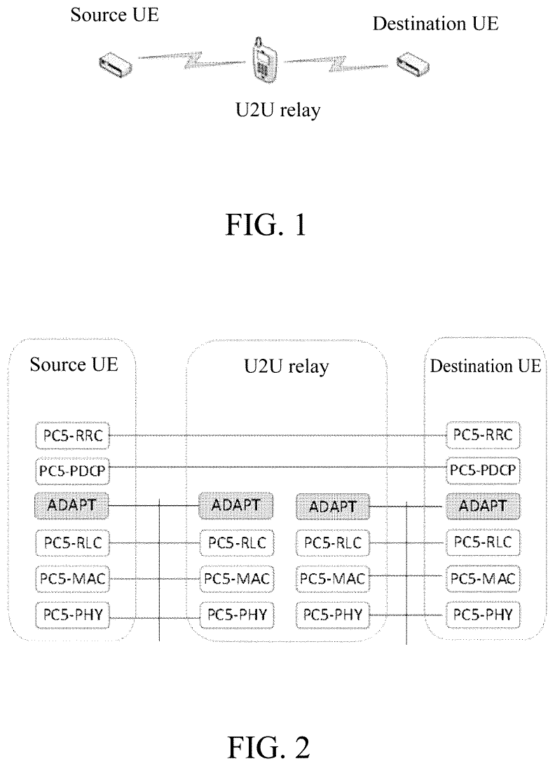

In practice, it is possible that two UE cannot directly communicate with each other, so the sidelink connection described above may be achieved by means of a relay UE, as shown in FIG. 1. Two UE that need to set up a communication connection may be referred to as remote UE. One of the remote UE is a source UE or is a transmission UE (TX UE), and is referred as a remote UEA (simply referred to as UE A). The other is a destination UE or a receiving UE (RX UE), and is referred as a remote UEB (simply referred to as UE B). The two remote UE are respectively wirelessly connected to the relay UE by using a Proximity services communication means. A connection means may be the PC5 connection or sidelink connection mentioned above or other communication connections, so that the PC5 connection/sidelink connection described above is indirectly set up between the two remote UE.

Such a relay UE may be referred to as a UE to UE (U2U) relay UE. Such a remote UE may be referred to as a U2U remote UE.

For the communication mode in FIG. 1, sidelink communication is used as an example, and control plane protocol stacks of a remote UE and a relay UE are as shown in FIG. 2.

After the remote UE A (the source UE or the TX UE) selects a relay UE to provide a relay service for the remote UE A, the remote UE A sets up a PC5-RRC connection with the relay UE, so as to communicate with the remote UE B (the destination UE or the RX UE) by means of the relay UE. The UE A may set up a PC5 connection with the UE B by means of the relay UE for data transmission between the UE A and the UE B. The UE A first performs, by means of a PC5 PDCP layer, data encapsulation on a message such as a sidelink RRC reconfiguration (RRCReconfigurationSidelink) transmitted to the UE B, and then submits the same to an adaptation layer. In the adaptation layer, data transmitted to the UE B is submitted, according to a mapping relationship, to a link of the relay UE corresponding to the UE B, and then the data is forwarded to a corresponding PC5 RLC entity so as to be further encapsulated, borne on a PC5 RLC channel, and then transmitted to the relay UE by being submitted downwards layer by layer by means of a PC5-MAC and a PC5-PHY. Upon receiving the data carrying the message, the relay UE submits the same upwards layer by layer by means of the PC5-PHY and PC5-MAC. In the adaptation layer, the relay UE determines, according to a link mapping relationship, a PC5 RLC channel corresponding to a link for transmission to the UE B, and transmits the message to the UE B by means of the PC5-MAC and PC5-PHY. Reversely, the UE B uses the same method to encapsulate a returned RRC message by means of a PC5 PDCP, submit the same to the adaptation layer, and transmit the same to the relay UE according to the mapping relationship, and then the relay UE transmits the message to the remote UE A.

### Sidelink Radio Link Failure (SL RLF)

In the following scenario, a UE may determine that a radio link failure has occurred on a sidelink connection for a specific destination:
upon indication from a sidelink RLC entity that the maximum number of retransmissions for a specific destination has been reached;
upon expiry of a timer T400 for a specific destination;
upon reception of indication from a MAC entity that the maximum number of consecutive HARQ DTX for a specific destination has been reached; or
upon integrity check failure indication from a sidelink PDCP entity concerning SL-SRB for a specific destination.

In a sidelink connection or a PC5 connection, one specific destination corresponds to one PC5 connection, therefore it can be considered that an SL RLF has occurred on a sidelink connection or a PC5 connection corresponding to the address.

### Timer T400

When a UE transmits an RRC reconfiguration sidelink message, the timer T400 is started for a corresponding destination. When the UE receives an RRC reconfiguration failure sidelink message or an RRC reconfiguration complete sidelink message, the timer T400 is stopped for a corresponding destination. Upon expiry of the T400, the UE considers that an SL RLF has occurred for the destination.

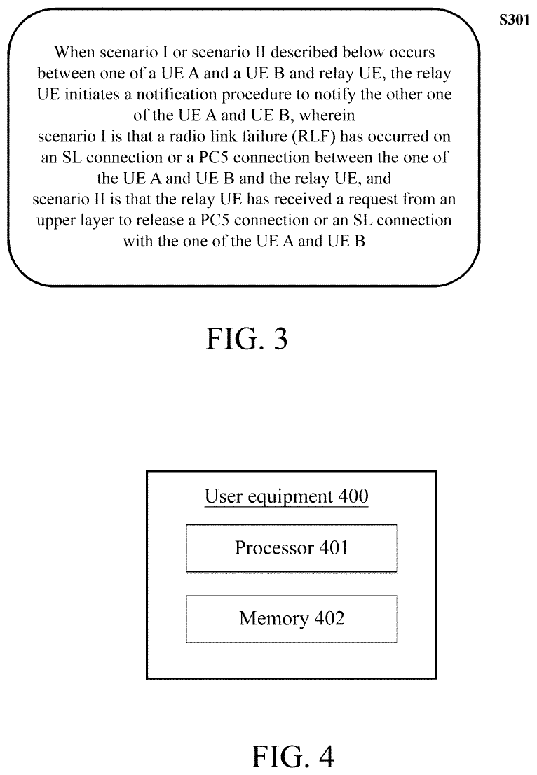

The method of the present invention is described below with reference to FIG. 3.

FIG. 3 shows a method performed by user equipment (UE) according to an embodiment of the present invention.

Specific embodiments are provided below to describe a processing method of the present invention.

### Embodiment 1

In the present embodiment, a processing method performed in a procedure wherein a remote user equipment (UE) A and another remote user equipment (UE) B set up a sidelink (SL) connection or a PC5 connection by means of a relay UE is provided, and as shown in FIG. 3, includes the following step:

Step S301: when scenario I or a scenario II described below occurs between one of the UE A and UE B and the relay UE, initiating, by the relay UE, a notification procedure to notify the other one of the UE A and UE B.
scenario I being that a radio link failure (RLF) has occurred on the SL connection or the PC5 connection between the one of the UE A and UE B and the relay UE, and
scenario II being that the relay UE has received a request from an upper layer to release the PC5 connection or the SL connection with the one of the UE A and UE B.

Specifically, the UE A and the UE B set up a connection by means of the relay UE, and the connection is, for example, a sidelink (SL) connection or a PC5 connection. The UE A and the UE B may both be referred to as U2U remote UE. In such a scenario, the relay UE may initiate a notification procedure in the following scenarios, and the procedure is used for the relay UE to transmit a notification to the U2U remote UE in a connection therewith:

The scenario I is that an RLF (SL RLF) has occurred on the sidelink connection/PC5 connection between the relay UE and one U2U remote UE (e.g., the UE A).

The scenario II is that the relay UE has received a request from the upper layer to release the PC5 connection or the sidelink connection with one U2U remote UE (e.g., the UE A). Alternatively, the scenario II is that the relay UE has received a request from the upper layer to release the PC5 connection with one remote UE, and the remote UE is one U2U remote UE. The upper layer herein refers to the non-access stratum of the relay UE, or the PC5-S layer of the UE for managing PC5 signaling, or the V2X layer for managing a PC5 connection, or the like.

Since the sidelink connection between the relay UE and one U2U remote UE (e.g., the UE A) corresponds to a group of transmission addresses or one destination, the scenario I and the scenario II may be respectively described as follows:

Scenario I: on the SL connection corresponding to the destination of one U2U remote UE (e.g., the UE A), the relay UE has detected an RLF, or an RLF has occurred.

Scenario II: the relay UE has received a request from the upper layer to release the PC5-RRC connection, and the connection is destined for one U2U remote UE (e.g., the UE A), or the destination of the connection corresponds to one U2U remote UE.

When the scenario I or II occurs, the relay UE initiates (triggers) a notification procedure. In the initiated notification procedure, the relay UE sends/transmits a sidelink RRC message to one U2U remote UE (e.g., the UE B), and the sidelink RRC message may be an existing Notification Message Sidelink message (sometimes also referred to as a first message) or a new message. The message is for notifying the remote UE (e.g., the UE B) that an RLF has occurred on the sidelink connection between the relay UE and the U2U remote UE (e.g., the UE A) at the other end, or that a corresponding PC5-RRC connection has been released. It may be considered that the scenario I or II triggers the transmission of the Notification Message Sidelink message.

A specific implementation may be that the relay UE sets an indication type according to a reason for triggering the transmission of the Notification Message Sidelink message.

When the reason for triggering the transmission of the Notification Message Sidelink message is a sidelink RLF (i.e., the scenario I), then the relay UE sets the indication type as sidelink RLF or PC5 RLF.

When the reason for triggering the transmission of the Notification Message Sidelink message is connection release or sidelink release (i.e., the scenario II), then the relay UE sets the indication type as sidelink release or PC5 release.

Then, the relay UE causes the set indication type to be carried in the Notification Message Sidelink message, and transmits the same to the U2U remote UE (e.g., the UE B). Optionally, the message further carries identification information, and the identification information is for identifying information of the remote UE (e.g., the UE A) in the scenario I or II. For example, the identification information corresponds to destination information of the remote UE (e.g., the UE A), or is a Layer-2 (L2) identity, or is destination identification information of the PC5 connections or sidelink connections corresponding to the two remote UE (e.g., the UE A and the UE B).

It should be noted that the notified U2U remote UE is not the remote UE (i.e., the UE A) described in the scenario I or II, but is the UE (i.e., the UE B) that sets up, by means of the relay UE, a communication connection with the remote UE described in the scenario I or II. Specifically:
the UE A and the UE B set up a connection by means of the relay UE, and the scenario I or II has occurred between the UE B and the relay UE, and so the relay UE initiates a notification procedure to notify the UE A. The Notification Message Sidelink message is transmitted to the UE B, and optionally, the message carries an identifier or destination information corresponding to the UE A, or identification information corresponding to the connection between the UE A and the UE B.

Alternatively, the UE A and the UE B set up a connection by means of the relay UE, and the scenario I or II has occurred between the UE A and the relay UE, and so the relay UE initiates a notification procedure to notify the UE B. The Notification Message Sidelink message is transmitted to the UE A, and optionally, the message carries an identifier or destination information corresponding to the UE B, or identification information corresponding to the connection between the UE A and the UE B.

### Embodiment 2

On the basis of Embodiment 1, when one U2U remote UE (e.g., the UE B) receives the Notification Message Sidelink message, the UE B may consider (determine) that an RLF has occurred on the sidelink connection set up between the UE B and the UE A, and optionally, for the sidelink connection between the UE A and the UE B or the sidelink connection destined for the UE A, one or a plurality of the following operations is/are performed:
considering that an RLF has occurred on the connection between the UE A and the UE B, or an RLF has occurred or been detected on the connection corresponding to the destination of the UE A;
releasing a DRB and/or an SRB corresponding to the destination, wherein preferably, only a PC5 PDCP entity of the DRB/SRB that performs communication by means of U2U relay is released;
releasing/discarding configuration information in a SRAP and corresponding to the destination or associated with the destination;
if T400 associated with the destination is running, stopping the timer;
discarding NR sidelink communication related configuration information associated with the destination;
considering that the PC5-RRC connection associated with the destination has been released; or indicating to the upper layer that the PC5-RRC connection associated with the destination has been released.

Embodiment 2 may also be implemented separately. When one U2U remote UE receives information, and the information indicates that a failure has occurred on the PC5/sidelink connection between the U2U remote UE connected thereto and the relay UE or when one U2U remote UE detects or considers that the connection to the other U2U remote UE at the other end has been released or has undergone an RLF, the U2U remote UE may perform the operations in Embodiment 2.

### Embodiment 3

On the basis of Embodiment 1, when one U2U remote UE (e.g., the UE A) detects that an RLF has occurred on the connection between the one U2U remote UE and the relay UE or the upper layer of the remote UE requests the remote UE to release a PC5-RRC connection to one relay UE, if the remote UE (e.g., the UE A) has a PC5-RRC connection/sidelink connection with another UE (e.g., the UE B) set up by means of the relay UE, then the remote UE may first perform the following operations for the sidelink connection between the remote UE and the relay UE or corresponding to the sidelink connection destined for the relay UE:
releasing a DRB and/or an SRB associated with the destination;
discarding NR sidelink communication related configuration information and/or U2U relay related configuration information associated with the destination;
considering that the PC5-RRC connection associated with the destination has been released;
indicating to the upper layer that the PC5-RRC connection associated with the destination has been released; and
resetting a MAC entity associated with the destination.

If the remote UE is in an RRC connected state, a sidelink UE information for NR sidelink communication procedure also needs to be performed to report corresponding information to a base station/network side.

Then, one or a plurality of the following operations is/are performed for the connection between the remote UE and the U2U remote UE (i.e., the UE A and the UE B):
considering that an RLF has occurred on the connection between the UE A and the UE B, or an RLF has occurred or been detected on the sidelink connection corresponding to the destination of the UE B;
releasing a DRB and/or an SRB associated with the destination, wherein preferably, only a PC5 PDCP entity of the DRB/SRB that performs communication by means of U2U relay is released;
releasing/discarding configuration information in a SRAP and corresponding to the destination or associated with the destination;
if T400 associated with the destination is running, stopping the timer;
discarding NR sidelink communication related configuration information associated with the destination;
considering that the PC5-RRC connection associated with the destination has been released;
indicating to the upper layer that the PC5-RRC connection associated with the destination has been released.

Embodiment 3 may also be implemented separately. When one U2U remote UE (e.g., the UE A) detects that an RLF has occurred on the connection between the one U2U remote UE and the relay UE or the upper layer of the remote UE requests the remote UE to release a PC5-RRC connection with one relay UE,

If the remote UE (e.g., the UE A) has a PC5-RRC connection to another UE (e.g., the UE B) set up by means of the relay UE, the U2U remote UE may perform the operations in Embodiment 3.

FIG. 4 is a simplified structural block diagram of user equipment according to the present invention.

As shown in FIG. 4, the user equipment 400 at least includes a processor 401 and a memory 402. The processor 401 may include, for example, a microprocessor, a microcontroller, an embedded processor, and the like. The memory 402 may include, for example, a volatile memory (for example, a random access memory (RAM)), a hard disk drive (HDD), a non-volatile memory (for example, a flash memory), or other memory systems. The memory 402 has program instructions stored thereon. When the instructions are run by the processor 401, one or several steps in the processing method described above can be performed.

The methods and related devices according to the present disclosure have been described above in conjunction with preferred embodiments. It should be understood by those skilled in the art that the method shown above is only exemplary, and the above embodiments can be combined with one another as long as no contradiction arises. The method of the present invention is not limited to the steps or sequences illustrated above.

The user equipment shown above may include more modules, for example, may also include modules that can be developed or developed in the future and can be used for base stations, MMEs, or UE, and so on. Various identifiers shown above are only exemplary, not for limitation, and the present disclosure is not limited to specific information elements serving as examples of these identifiers. A person skilled in the art could make various alterations and modifications according to the teachings of the illustrated embodiments.

It should be understood that the above embodiments of the present disclosure may be implemented through software, hardware, or a combination of software and hardware. For example, various components in the base station and user equipment in the above embodiments can be implemented by multiple devices, and these devices include, but are not limited to: an analog circuit device, a digital circuit device, a digital signal processing (DSP) circuit, a programmable processor, an application-specific integrated circuit (ASIC), a field-programmable gate array (FPGA), a complex programmable logic device (CPLD), and the like.

The program running on the device according to the present invention may be a program that enables the computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions may be achieved by reading programs recorded on the recording medium and executing the programs by a computer system. The so-called “computer system” may be a computer system embedded in the device, which may include operating systems or hardware (for example, peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed via circuits (for example, monolithic or multi-chip integrated circuits). Circuits designed to execute the functions described in the present specification may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1-10. (canceled)

11. A relay user equipment (UE), comprising:
a processor; and
a memory in electronic communication with the processor, wherein instructions stored in the memory are executable to:
initiate transmission of a notification message in a case that a Radio Link Failure (RLF) occurs over a PC5 connection with a remote UE, the notification message including a destination identity associated for the remote UE and an indication which refers to that the RLF has occurred over the PC5 connection with the remote UE.

12. The relay UE according to claim 11, wherein the instructions stored in the memory are executable to:
transmit the notification message to an other remote UE.

13. The relay UE according to claim 11, wherein the instructions stored in the memory are executable to:
initiate the transmission of the notification message in a case that an upper layer requests a release of a PC5 Radio Resource Control (RRC) connection of which destination is corresponding to an other remote UE.

14. A user equipment (UE), comprising:
a processor; and
a memory in electronic communication with the processor, wherein instructions stored in the memory are executable to:
upon reception of a notification message as a remote UE which includes an indication type as PC5 Radio Link Failure (RLF) and a destination identity associated with an other remote UE, perform actions which include:
release a Data Radio Bearers (DRB) and a Signaling Radio Bears (SRB) for a PC5 connection;
discard a New Radio (NR) sidelink communication related configuration for the PC5 connection;
consider a PC5 Radio Resource Control (RRC) connection is released for the PC5 connection; and
indicate a release of the PC5-RRC connection to an upper layer.

15. A method performed by relay user equipment (UE), the method comprising:
initiating transmission of a notification message in a case that a Radio Link Failure (RLF) occurs over a PC5 connection with a remote UE, the notification message including a destination identity associated for the remote UE and an indication which refers to that the RLF has occurred over the PC5 connection with the remote UE.
